(19) United States
(12) Patent Application Publication
(10) Pub. No.: US 2025/0259132 A1
(43) Pub. Date: Aug. 14, 2025

(54) DETERMINING RECIPIENT AVAILABILITY FOR RESCHEDULING PACKAGE DELIVERY

(71) Applicant: Motorola Mobility LLC, Chicago, IL (US)

(72) Inventors: Krishnan Raghavan, Bangalore (IN); Vijayprakash Idlur, Bengaluru (IN); A G Prasad, Bengaluru (IN)

(73) Assignee: Motorola Mobility LLC, Chicago, IL (US)

(21) Appl. No.: 18/439,165

(22) Filed: Feb. 12, 2024

(51) Int. Cl. G06Q 10/083; G06Q 10/1093

(52) U.S. Cl. CPC G06Q 10/083; G06Q 10/1095

(57) ABSTRACT

In aspects of determining recipient availability for rescheduling package delivery, a package delivery manager of a device (e.g., a client device and/or a server device) obtains application data that indicates an availability status of a recipient to receive a package delivery according to a delivery schedule. The availability status may indicate that the recipient is unavailable to receive the package delivery according to the delivery schedule. The package delivery manager establishes an updated schedule for the package delivery based on the availability status of the recipient indicating availability to receive the package delivery according to the updated schedule.

### BACKGROUND

Devices, such as smart devices, mobile devices (e.g., cellular phones, tablet devices, smartphones), consumer electronics, and the like, can be implemented for use in a wide range of environments and for a variety of different applications. For example, a device can implement a marketplace application that provides for a user to purchase items. The marketplace application can include a user interface for displaying products to the user. The user may interact with the user interface to purchase products for delivery or pickup, to return products that were previously purchased, to receive personalized product recommendations, to receive notifications related to the marketplace application, and more. Packages ordered by the user may be delivered to a physical location, such as to a place of residence of the user.

### BRIEF DESCRIPTION OF THE DRAWINGS

Implementations of the techniques for determining recipient availability for rescheduling package delivery are described with reference to the following Figures. The same numbers may be used throughout to reference like features and components shown in the Figures:

FIG. 1 illustrates an example system for determining recipient availability for rescheduling package delivery in accordance with one or more implementations as described herein.

FIGS. 2 and 3 further illustrate example user interfaces of a device, which supports determining recipient availability for rescheduling package delivery in accordance with one or more implementations as described herein.

FIG. 4 further illustrates an example block diagram for determining recipient availability for rescheduling package delivery in accordance with one or more implementations as described herein.

FIG. 5 further illustrates an example process flow, which supports determining recipient availability for rescheduling package delivery in accordance with one or more implementations as described herein.

FIG. 6 illustrates an example method for determining recipient availability for rescheduling package delivery in accordance with one or more implementations of the techniques described herein.

FIG. 7 illustrates various components of an example device that can be used to implement the techniques for determining recipient availability for rescheduling package delivery as described herein.

### DETAILED DESCRIPTION

Implementations of techniques for determining recipient availability for rescheduling package delivery are described herein. In some examples, a customer may order a product or an item from an online marketplace. A delivery service may deliver a package including the product to a physical location of an intended recipient of the package. For example, the customer may specify a delivery location (e.g., address) and a delivery date when purchasing a product from the online marketplace. A delivery agent of the delivery service may deliver the package to the specified delivery location on the delivery date. In some examples, the delivery location may not be secure, so the delivery agent may wait to deliver the package until the intended recipient is available to receive the package at the physical location. However, the intended recipient may not be available to receive the package for an extended duration, causing security risks due to exposing sensitive information related to the availability of the intended recipient, risk of theft or damage to the package if the delivery agent delivers when the intended recipient is not available, as well as additional use of computational resources for the delivery service due to processing of additional package delivery attempts.

Thus, to reduce or prevent the security risks, the risk of theft or damage, and/or the use of additional computational resources, a mobile device of an intended recipient of a package and/or a server device of the delivery service that is in communication with the mobile device can predict an availability status of the intended recipient of the package. The device can obtain application data (e.g., from one or more applications running on the device and/or by accessing a database that stores application data) that indicates whether the user of the device, or an intended recipient of the package, is available during a scheduled delivery of the package. The application data can include calendar information of the intended recipient of the package, travel information of the intended recipient of the package, correspondence information of the intended recipient of the package, a home automation system of the intended recipient of the package, and/or location information of the intended recipient of the package.

If the device determines an intended recipient is unavailable during a scheduled delivery of the package, the device analyzes the application data to determine an updated schedule for the package delivery for when the intended recipient of the package is available. For example, if an intended recipient of a package schedules a calendar event to occur during the scheduled delivery, the device can determine an alternative delivery schedule (e.g., date and time) during which the intended recipient is available. The device transmits the updated schedule to a device of an agent responsible for delivery of the package, such that the agent adjusts the delivery of the package according to the updated schedule. In some examples, the availability status of the intended recipient of the package may change prior to delivery of the package according to the updated schedule (e.g., the intended recipient may become available sooner and/or may not be available to receive the delivery during the updated schedule), so the device continues to monitor for additional application data indicating the availability status of the intended recipient of the package until the package is delivered.

While features and concepts of the described techniques for determining recipient availability for rescheduling package delivery can be implemented in any number of different devices, systems, environments, and/or configurations, implementations of the techniques for determining recipient availability for rescheduling package delivery are described in the context of the following example devices, user interfaces, systems, and methods.

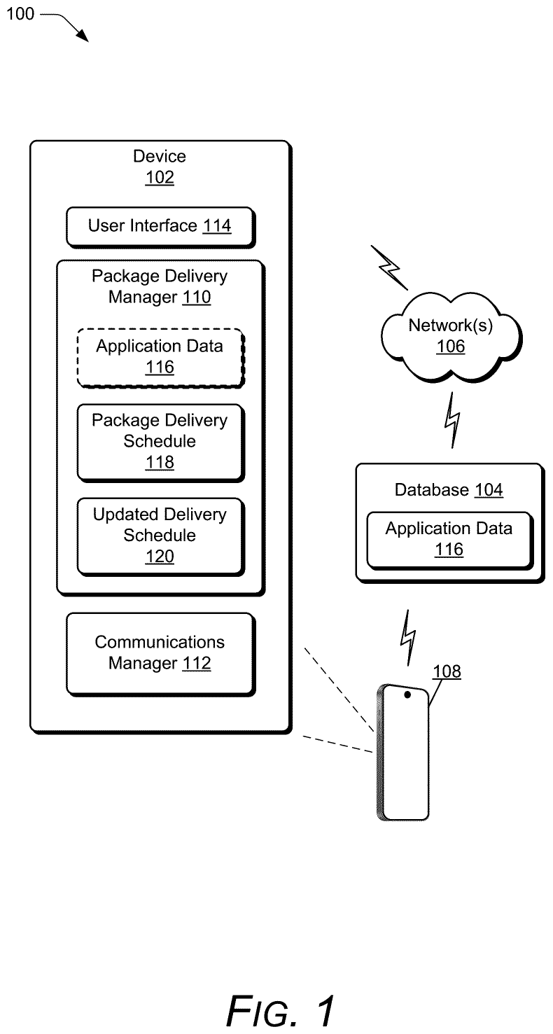

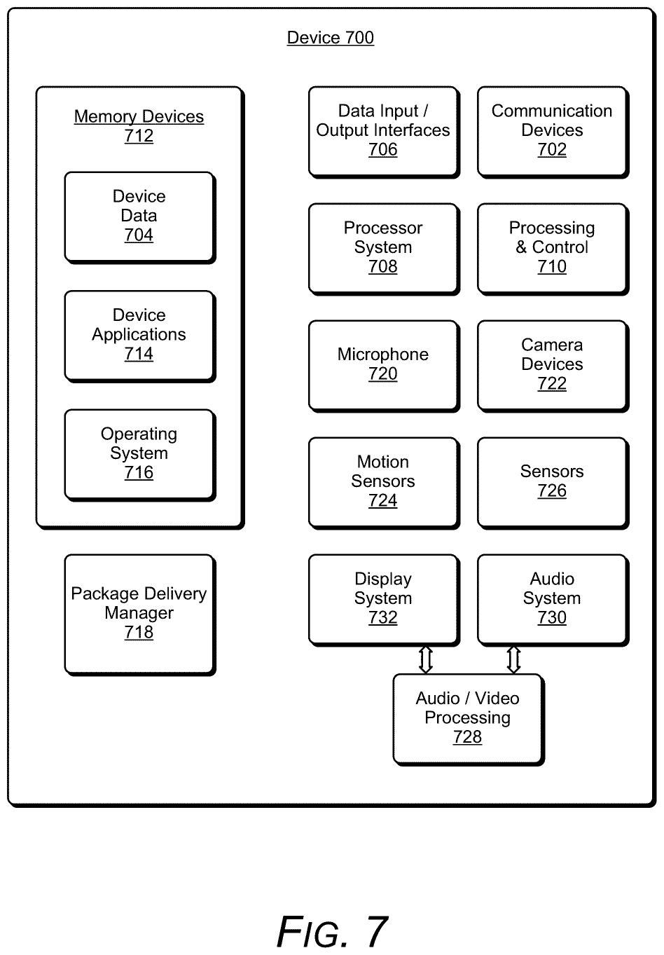

FIG. 1 illustrates an example system 100 for determining recipient availability for rescheduling package delivery, as described herein. The example system 100 includes a device 102 and a database 104, where the device 102 and the database 104 are interconnectable via one or more networks 106. In some examples, the device 102 include a server device, a client device, a smartphone, a mobile phone, and/or any other type of wireless device or mobile device 108. The device 102 can be implemented with various components, such as a processor system and memory, as well as any number and combination of different components as further described with reference to the example device shown in FIG. 7. In implementations, the device 102 includes various radios for wireless communication with other devices (e.g., via the networks 106). For example, the device 102 may include a Bluetooth (BT) and/or Bluetooth Low Energy (BLE) transceiver and/or a near field communication (NFC) transceiver. The device 102 can also include a Wi-Fi radio, a global positioning system (GPS) radio, and/or any type of device communication interfaces.

In some examples, a customer places an order for an item for sale via an online marketplace application. A delivery service ships the item from an initial location (e.g., a location of manufacture) to a final destination, which can be specified by the customer via the online marketplace application. For example, the customer specifies a physical address of an intended recipient of the package including the item. In some examples, the delivery service includes one or more delivery agents that are responsible for delivering the package. In some cases, the delivery agents include one or more people hired to deliver the package, devices or machines configured to deliver the package (e.g., drone delivery, autonomous vehicle delivery, or delivery by another device or machine), or both. It is to be appreciated that the delivery agent can be a human delivery agent or a non-human delivery agent. In some examples, the delivery service provides the delivery agent with an address to a physical location to deliver the package, where the address is specified by the customer via the online marketplace application.

In some examples, the physical location for delivery of the package may not be secure, so the delivery agent may wait to deliver the package until an intended recipient is available to receive the package at the physical location (e.g., to sign for the package and/or otherwise confirm the receipt of the package in person). However, waiting to deliver a package until an intended recipient is available causes delayed receipt of the package and inconvenience and frustration for the intended recipient of the package, as well as inefficient use of computational resources due to processing redelivery attempts of the package. Additionally, or alternatively, waiting to deliver the package until an intended recipient is available can cause inefficient use of computational resources due to an increase in messaging between the intended recipient and one or more agents of the delivery service (e.g., customer service interactions). Further, the delivery agent is exposed to sensitive information including that the intended recipient is not available to receive the package, causing potential security risks for the intended recipient (e.g., risk of theft, property damage, personal harm, etc.). If the delivery agent does not wait to deliver the package until an intended recipient is available, the package can be exposed to risk of theft or damage.

In some examples, an intended recipient is unavailable to receive a package delivery for an extended period of time. An online marketplace application can display an estimated delivery date and time to a customer purchasing the item. However, the customer may be unaware of the availability status of the intended recipient when purchasing the item. Additionally, or alternatively, the customer may forget or otherwise lose track of an estimated delivery date of a package for delivery (e.g., due to insufficient tracking alerts for the delivery schedule of the package, lack of subscription by the intended recipient to tracking alerts for the delivery schedule of the package, and/or due to frequently occurring or periodic deliveries). Additionally, or alternatively, the delivery of the package can be delayed, which is outside of the control of the intended recipient.

For example, a customer orders an item in September, and the package is scheduled to be delivered to the customer October 20. The customer does not receive a reminder about the package delivery and schedules a trip on October 20. Thus, the customer is not available to receive the package during the scheduled delivery. A delivery agent of the delivery service attempts to deliver the package, but the delivery attempt is unsuccessful due to the customer not being available to sign for the package. The delivery agent leaves a notification that the package is unable to be delivered. When the customer is available to receive the package, the customer sends a notification to the delivery service to reschedule the delivery of the package, causing increased usage of computational resources due to additional signaling between the delivery service and the customer.

To reduce, or eliminate, increased usage of computational resources due to redelivery attempts of a package for delivery, a device 102 proactively determines, or predicts, if an intended recipient of a package scheduled for delivery is available or unavailable to receive the package during the scheduled delivery. In some examples, the device 102 is a client device, such as a client device of an intended recipient of a package. In some other examples, the device 102 is a server device of a delivery service. The device 102 includes various functionality that enables the device 102 to perform different aspects of determining recipient availability for rescheduling package delivery discussed herein, including a package delivery manager 110, a communications manager 112, and a user interface 114. The package delivery manager 110 represents functionality (e.g., logic and hardware) for enabling the device 102 to obtain application data 116 related to an availability status of an intended recipient of a package to receive the package according to a package delivery schedule 118.

For example, if the device 102 is a client device of an intended recipient of a package, then the device 102 obtains the application data 116 directly from one or more applications running at the device 102 (e.g., via a database local to the device 102 that stores the application data 116 for each application). The device 102 is configured to run one or more applications, such as a calendar application that tracks scheduled events for the intended recipient of the package (e.g., a work calendar, a personal calendar, etc.), travel applications that provide for the intended recipient to schedule and manager travel plans, one or more correspondence applications for messaging (e.g., text messaging, email, or other electronic correspondence), a home automation application that monitors statuses of different components of a home automation system (e.g., temperature control, lights, a security system, or any other components of a home automation system), location applications that track a geographic location of the intended recipient, among other applications. The application data 116 includes at least one of calendar information of the recipient, travel information of the recipient, correspondence information of the recipient, a home automation system associated with the recipient, or location information of the recipient that is collected from the applications.

In some examples, if the device 102 is a server device of a delivery service, then the device 102 accesses a database 104 to obtain the application data 116. For example, the device 102 is one or more of a web server, an application server, or a cloud server, among others. A client device of the intended recipient collects and stores the application data 116 at a database 104, which can be an example of a remote database (e.g., cloud or network-based database), a physical database, a local database at the client device, or the like. In some examples, the database 104 can be hosted at a device 102 (e.g., a client device or a server device), which is an example of a local database. The device 102 can store the application data 116 at the local database. For example, a client device of the intended recipient stores the application data 116 at a local database at the client device, and the server device accesses the application data 116 by communicating directly with the client device to obtain the application data 116 from the local database of the client device. In some cases, the device 102 connects to a remote database, or cloud database, to access and/or store the application data 116, among other data. For example, the client device of the intended recipient stores the application data 116 at a database remote from the client device, and the server device accesses the application data 116 from the remote database.

If the database 104 is a remote database and/or is hosted at a server device of a delivery service, then a client device of an intended recipient can store application data 116 at the database 104 via the networks 106. Similarly, if the database 104 is a remote database and/or a local database at the client device, then the server device can access the application data 116 at the database 104 via the networks 106. For example, the device 102 can include a communications manager 112 for accessing the database 104 to store the application data 116 and/or to obtain the application data 116. The communications manager 112 represents functionality (e.g., logic and hardware) for enabling the device 102 to interconnect with other devices and/or networks, such as the networks 106. The communications manager 112, for instance, enables wireless and/or wired connectivity of the device 102. For example, the communications manager 112 represents one or more antennas for transmitting and receiving signaling from other devices and/or the database 104 via the networks 106.

The networks 106 can include computer networks and/or telecommunication networks. For example, the networks 106 include a wireless local area network (WLAN), a wireless network, a BT network, a cellular network, a satellite network, and/or a fiber optic network. The networks 106 connect one or more devices, such as the device 102 and the database 104, among others.

The package delivery manager 110 can obtain the application data 116 and can analyze the application data 116 to determine an availability status of the intended recipient of a package for delivery. For example, calendar information from a calendar application includes a date and time of one or more events of an intended recipient, such as meetings, time out of office, appointments, social events, and other events. The package delivery manager 110 can compare a date and time of the events to a delivery schedule that is determined when a customer places an order for an item in the package. The delivery schedule can include a date and time (e.g., a date including a month, day, and year and a time window approximating the delivery of the package during that date). If the date and time of an event overlaps with the delivery schedule, then the intended recipient of the package may not be available to receive the package during the delivery schedule. Additionally, or alternatively, if the delivery schedule does not overlap with an event, then the intended recipient of the package may be available to receive the package during the delivery schedule. For example, if an intended recipient schedules a meeting on Monday between 3:00 and 4:00 pm, and a package is scheduled to be delivered between 3:00 and 3:30 pm, then the package delivery manager 110 determines that the intended recipient is not available to receive the package during the scheduled delivery.

Similarly, the package delivery manager 110 can determine whether an intended recipient is available or unavailable to receive a package by analyzing travel information from a travel application. The travel information can include a date range and/or time range during which an intended recipient may be unavailable to receive a package (e.g., parking data from a reservation at an airport parking lot, train ticket purchase data, plane ticket purchase data, rental car reservation data, etc.), and the package delivery manager 110 can compare a delivery schedule for the package to the travel information. If the delivery schedule does not overlap with a date range and/or time range during which the intended recipient is unavailable, then a delivery agent may deliver the package according to the delivery schedule. However, if the delivery schedule does overlap with a date range and/or time range during which the intended recipient is unavailable, then a delivery agent may not deliver the package according to the delivery schedule. For example, the package delivery manager 110 determines an intended recipient of a package plans a vacation and is unavailable to receive a package from Monday at 8:00 am to Wednesday at 4:30 pm based on data from a travel application indicative of a parking reservation at an airport parking lot for that date range and time range. If the scheduled delivery for the package overlaps with the date and time range of the parking reservation (e.g., Tuesday), then the package delivery manager 110 determines the intended recipient is unavailable to receive the package.

Additionally, or alternatively, the package delivery manager 110 can determine whether an intended recipient is available or unavailable to receive a package by analyzing correspondence data from a correspondence application. The correspondence data can include a message indicating a date range and/or time range during which an intended recipient may be unavailable to receive a package (e.g., an email confirming a date and/or time range during which an intended recipient is going to be unavailable, a text message indicating an intended recipient is going to be unavailable and a date and/or time range, etc.), and the package delivery manager 110 can compare a delivery schedule for the package to the correspondence data. If the delivery schedule does not overlap with a date range and/or time range during which the intended recipient is unavailable, then a delivery agent may deliver the package according to the delivery schedule. However, if the delivery schedule does overlap with a date range and/or time range during which the intended recipient is unavailable, then a delivery agent may not deliver the package according to the delivery schedule. For example, the package delivery manager 110 determines an intended recipient of a package is out of town and unavailable to receive a package from Monday at 8:00 am to Wednesday at 4:30 pm based on an email indicating flight information data for that date range and time range to a colleague. If the scheduled delivery for the package overlaps with the date and time range of the flight information data (e.g., Tuesday), then the package delivery manager 110 determines the intended recipient is unavailable to receive the package.

Additionally, or alternatively, the package delivery manager 110 can determine whether an intended recipient is available or unavailable to receive a package by analyzing home automation system data from a home automation system application. The home automation system data can include a date range and/or time range for an away status of the home automation system, a data range and/or time range for an eco-status to reduce an energy usage of one or more components of the home automation system, a security system status of the home automation system, temperature data, and a status of other components of the home automation system. For example, if the intended recipient programs an away status and/or eco status of the home automation system to “away” and/or “eco,” respectively, for a defined date range and/or time range, the package delivery manager 110 determines that the intended recipient is unavailable to receive the package during the defined date range and/or time range. If the intended recipient interacts with the components of the home automation system via the home automation system application, then the package delivery manager 110 analyzes the interactions to determine whether the intended recipient is available to receive the package or is unavailable to receive the package. For example, if the intended recipient turns on lights, disables a security system, or the like, the package delivery manager 110 determines that the intended recipient is available to receive the package. In some other examples, if the intended recipient turns off lights, enables a security system, or the like, the package delivery manager 110 determines that the intended recipient is unavailable to receive the package.

In some examples, to avoid the package delivery manager 110 from falsely determining the intended recipient is available or unavailable (e.g., due to turning lights on or off from a natural light level, enabling a security system while at home, placing the home automation system in an eco-status due to outside temperatures, etc.), the package delivery manager 110 can utilize multiple components of the home automation system data to determine whether the intended recipient is available or unavailable to receive the package. For example, if the package delivery manager 110 analyzes the home automation system data and determines that an intended recipient turns off one or more lights at a same time as, or within a threshold duration, from enabling a security system and/or placing the home automation system in the eco status, then the package delivery manager 110 can have a higher degree of confidence that the intended recipient is unavailable to receive the package delivery. Similarly, if the package delivery manager 110 analyzes the home automation system data and determines that an intended recipient turns on one or more lights at a same time as, or within a threshold duration, as disabling a security system and/or taking the home automation system out of an eco-status, then the package delivery manager 110 can have a relatively high degree of confidence that the intended recipient is available to receive the package delivery.

The package delivery manager 110 can compare a delivery schedule for the package to a date and/or time of a programmed away status of the home automation system and/or to a date and/or time of a determination of an availability status of the intended recipient. If the delivery schedule does not overlap with date ranges and/or time ranges during which the intended recipient is unavailable, then a delivery agent may deliver the package according to the delivery schedule. However, if the delivery schedule does overlap with a date range and/or time range during which the intended recipient is unavailable, then a delivery agent may not deliver the package according to the delivery schedule. For example, the package delivery manager 110 determines package is scheduled to be delivered at 10:00 am, but an intended recipient of a package left the house (e.g., is unavailable) at 8:00 am and has not returned by 10:00 am based on the home automation system data. Thus, the intended recipient is unavailable during the scheduled delivery.

Additionally, or alternatively, the package delivery manager 110 can determine whether an intended recipient is available or unavailable to receive a package according to a delivery schedule by analyzing location data from a location application. The location data can include a geographic location of the intended recipient. If the intended recipient is at a location other than the location specified for delivery of the package at a time during which the delivery is scheduled and/or for a threshold duration, then the intended recipient may be unavailable to receive the package. In some examples, the package delivery manager 110 determines a threshold distance from the location specified for delivery of the package, and if the intended recipient is outside of the threshold distance, then the intended recipient is unavailable to receive the package. The threshold distance can be based on the delivery schedule. For example, if the delivery is scheduled in an hour, and the intended recipient is at a location more than an hour travel time away from the location specified for delivery of the package, then the package delivery manager 110 determines the intended recipient is unavailable to receive the package. If the intended recipient is at the location specified for delivery of the package and/or is within a threshold distance of the location specified for delivery of the package, then the intended recipient may be available to receive the package. Additionally, or alternatively, the package delivery manager 110 can determine that an intended recipient is unavailable to receive the package if the intended recipient has been at a location other than the delivery location for an extended duration (e.g., more than a threshold duration).

If the package delivery manager 110 analyzes the application data 116 and determines that the intended recipient of the package is not available to receive the package during a scheduled delivery, then the availability status of the intended recipient is unavailable. The package delivery manager 110 determines an updated package delivery schedule 120 that includes an update to the package delivery schedule 118 by analyzing the application data 116 to determine when the intended recipient of the package is available to receive the package. If the intended recipient is available to receive the package during the package delivery schedule 118 and/or the updated package delivery schedule 120, then the availability status of the intended recipient is available. The package delivery manager 110 can transmit an indication of the package delivery schedule 118 and/or the updated package delivery schedule 120 to one or more client devices of agents of a delivery service (e.g., a client device of a delivery agent), such that the agents deliver the package according to the package delivery schedule 118 and/or the updated package delivery schedule 120. The package delivery manager 110 can continue to monitor the application data 116 to determine if there are additional changes to an availability status of the intended recipient of the package. For example, the intended recipient may become available prior to the updated package delivery schedule 120, and the package delivery manager 110 can further update the package delivery schedule 118 and/or the updated package delivery schedule 120 according to the availability. In some other examples, the intended recipient may still not be available during the updated package delivery schedule 120, and the package delivery manager 110 can further update the package delivery schedule 118 and/or the updated package delivery schedule 120 according to the availability.

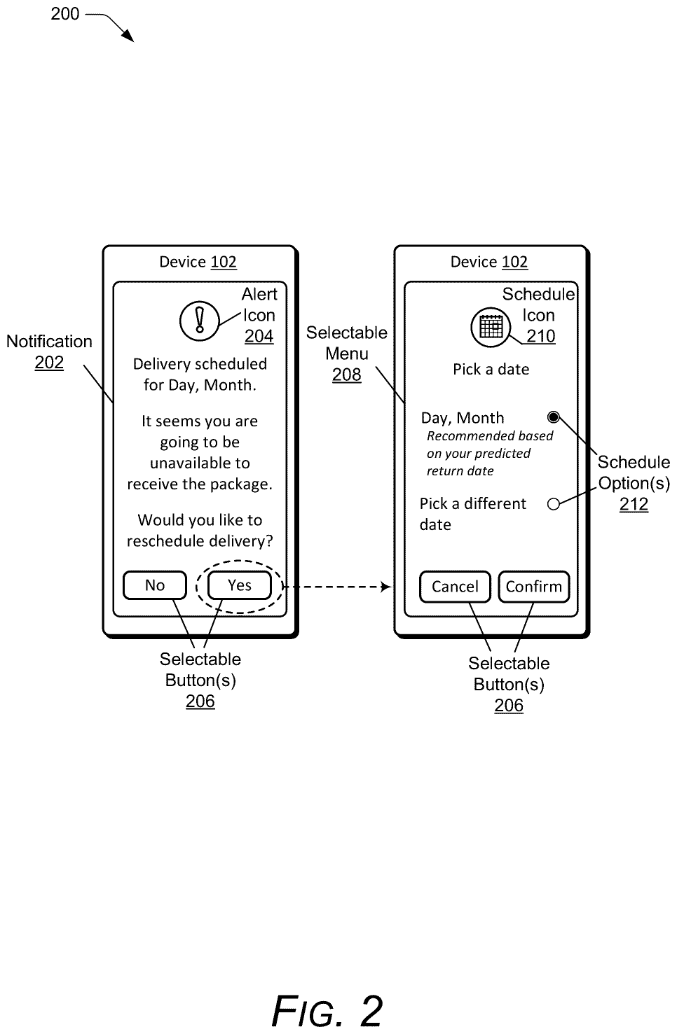

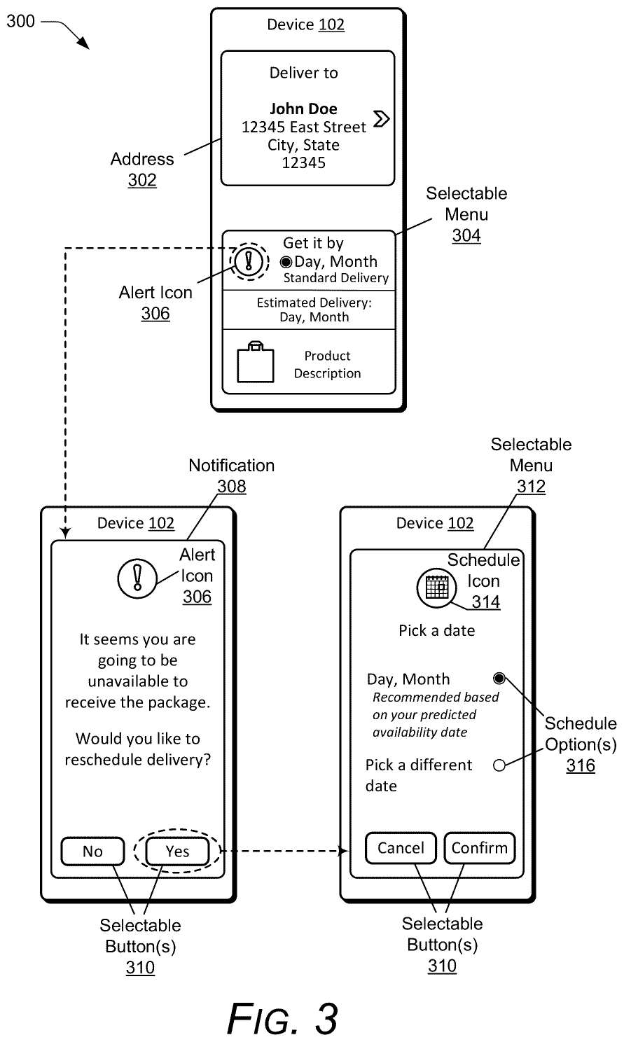

In variations where the device 102 is the client device of the intended recipient, the device 102 includes a user interface 114 that displays interactive elements (e.g., icons, buttons, windows, menus, etc.) that the intended recipient can view and interact with. For example, if the package delivery manager 110 determines that the intended recipient of the package is not available to receive the package during a scheduled delivery, the device 102 can display a notification or message indicating an updated schedule for delivery of the package to the intended recipient via a user interface 114 of a mobile device 108 of the intended recipient, which is described in further detail with respect to FIG. 2. In some other examples, a device 102 of a customer ordering an item can determine that an intended recipient of a package including the item is unavailable to receive the package during an estimated delivery date and/or time. The device 102 can display a message to a user of the device 102 (e.g., an intended recipient of a delivery of the package) indicating that the intended recipient is unavailable to receive the package and a recommendation of an updated package delivery schedule, which is described in further detail with respect to FIG. 3.

FIG. 2 illustrates an example user interface 200 of a device, which supports determining recipient availability for rescheduling package delivery in accordance with one or more implementations as described herein. The example user interface 200 may implement aspects of the example system 100 as shown and described with reference to FIG. 1. For example, the example user interface 200 may illustrate an example of a message displayed at a device 102 of an intended recipient of a package for delivery. The device 102 is an example of a device 102 as described with reference to FIG. 1. For example, the device 102 can be a client device, or mobile device, of the intended recipient of the package for delivery.

A device 102 can determine whether an intended recipient of a package is available to receive the package according to a delivery schedule, as described with reference to FIG. 1. In some cases, if the intended recipient of the package is not available to receive the package according to the delivery schedule, the device 102 selects an updated package delivery schedule for when the intended recipient is expected to be available to receive the package. The device 102 can automatically update (e.g., without user input) the package delivery schedule to the updated package delivery schedule and can notify the intended recipient of the update. Additionally, or alternatively, the device 102 can display a notification 202 to the intended recipient via the example user interface 200. The notification 202 can include an alert icon 204 that indicates the notification 202 is an alert. The notification 202 can include text, such as “Delivery scheduled for Day, Month. It seems you are going to be unavailable to receive the package. Would you like to reschedule delivery?” The notification 202 can also include selectable buttons 206, such as a “Yes” button and a “No” button.

In some examples, if the intended recipient (e.g., a user of the device 102) provides user input by selecting, clicking, or otherwise activating the “Yes” selectable button 206, then the device 102 can display a selectable menu 208. The selectable menu 208 can include a schedule icon 210 indicating that the selectable menu 208 is for scheduling. The selectable menu 208 can include scheduling options 212 based on a predicted availability date and/or time of the intended recipient of the package. For example, the scheduling options 212 can include an option to select a date (e.g., Day, Month) that the device 102 predicts the intended recipient is available and/or an option to select a different date. The option to select a date that the device 102 predicts the intended recipient is available can display a message “Recommended based on your predicted return date.” The selectable menu 208 can include selectable buttons 206, such as a “Cancel” selectable button 206 and a “Confirm” selectable button 206. Upon selection, the “Confirm” selectable button 206 updates the scheduled delivery date to the scheduling option selected by the intended recipient of the package. Additionally, or alternatively, if the “Cancel” selectable button 206 is selected, then the device 102 returns to displaying the notification 202 without updating the scheduled delivery date.

FIG. 3 illustrates an example user interface 300 of a device, which supports determining recipient availability for rescheduling package delivery in accordance with one or more implementations as described herein. The example user interface 300 may implement aspects of the example system 100 as shown and described with reference to FIG. 1. For example, the example user interface 300 may illustrate an example of a message displayed at a device 102 of an intended recipient of a package for delivery. The device 102 is an example of a device 102 as described with reference to FIG. 1. For example, the device 102 can be a client device, or mobile device, of the intended recipient of the package for delivery.

In some examples, a customer specifies an address 302 of an intended recipient of a package delivery when placing an order for an item to be delivered. The customer may specify the address 302 via the example user interface 300, which is an example of a user interface displaying an online marketplace application. The address can include a name of the intended recipient, a street address of the intended recipient, a city of the intended recipient, a state of the intended recipient, and/or a zip code of the intended recipient (e.g., John Doe, 12345 East Street, City, State, 12345). The example user interface 300 can include a selectable menu 304 that provides for the customer to specify a delivery option, including a date and/or time of delivery and a type of delivery (e.g., standard delivery, expedited delivery, etc.), and that displays a description of the product. If the device 102 determines the intended recipient is unavailable during an estimated delivery date and/or time for delivery of the package (e.g., prior to the customer placing the order for the item), as described with reference to FIG. 1, then the device 102 can present an alert icon 306 to the customer notifying the customer of the availability of the intended recipient of the package during the scheduled delivery.

The intended recipient can interact with the alert icon 306 (e.g., hover, click, or otherwise select) to display a notification 308. The notification 308 can include an alert icon 306 that indicates the notification 308 is an alert. The notification 308 can include text, such as “It seems you are going to be unavailable to receive the package. Would you like to reschedule delivery?” The notification 308 can also include selectable buttons 310, such as a “Yes” button and a “No” button.

In some examples, if the intended recipient (e.g., a user of the device 102) provides user input by selecting, clicking, or otherwise activating the “Yes” selectable button 310, then the device 102 can display a selectable menu 312. The selectable menu 312 can include a schedule icon 314 indicating that the selectable menu 312 is for scheduling. The selectable menu 312 can include scheduling options 316 based on a predicted availability date and/or time of the intended recipient of the package. For example, the scheduling options 316 can include an option to select a date (e.g., Day, Month) that the device 102 predicts the intended recipient is available and/or an option to select a different date. The option to select a date that the device 102 predicts the intended recipient is available can display a message “Recommended based on your predicted return date.” The selectable menu 312 can include selectable buttons 310, such as a “Cancel” selectable button 310 and a “Confirm” selectable button 310. Upon selection, the “Confirm” selectable button 310 updates the scheduled delivery date to the scheduling option selected by the intended recipient of the package. Additionally, or alternatively, if the “Cancel” selectable button 310 is selected, then the device 102 returns to displaying the notification 308 and/or the selectable menu 304 without updating the scheduled delivery date.

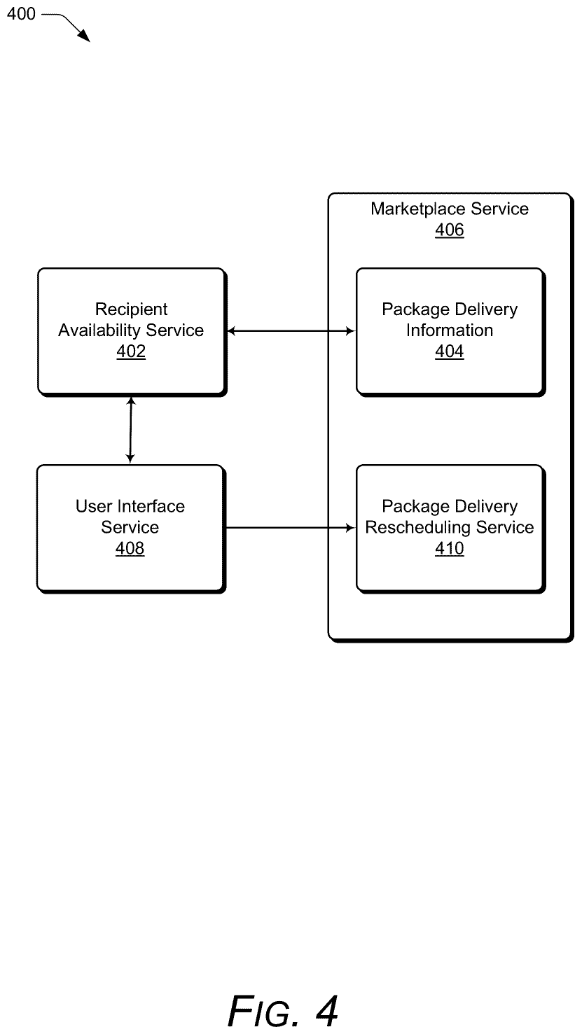

FIG. 4 illustrates an example block diagram 400 for determining recipient availability for rescheduling package delivery in accordance with one or more implementations as described herein. The block diagram 400 may implement aspects of the example system 100, as well as any of the example user interface 200 or the example user interface 300. For example, the example block diagram 400 can be implemented by a device 102, which may be an example of the device 102 as described with reference to FIGS. 1 through 4.

The example block diagram 400 includes a recipient availability service 402, which can be implemented at a device (e.g., a client device of an intended recipient of a package and/or a server of a delivery service). The recipient availability service 402 determines an availability status of an intended recipient of a package, as described with reference to FIG. 1. For example, the recipient availability service 402 obtains application data and package delivery information 404 from a marketplace service 406 and compares the application data with the package delivery information 404 to determine whether or not an intended recipient is available to receive a package during a scheduled delivery of the package. If the intended recipient is not available, then the recipient availability service 402 can coordinate with a user interface service 408 to display a notification alerting the intended recipient that they will be unavailable to receive the package during the scheduled delivery.

In some examples, the marketplace service 406 is implemented by one or more devices to list one or more items for sale. For example, the devices run online marketplace applications that display item listings for items for sale via the marketplace service 406. The marketplace service 406 can coordinate with a delivery service to obtain the package delivery information 404 and/or reschedule a package delivery. In some examples, a device can automatically reschedule a package delivery by updating a delivery schedule to a date and/or time when the intended recipient is available (e.g., using the application data). In some other examples, the device can prompt an intended recipient to update the delivery schedule to a selected, or otherwise indicated, date and/or time when the intended recipient is available (e.g., via the user interface service 408). The user interface service 408 provides a package delivery rescheduling service 410 of the marketplace service 406 with the updated package delivery schedule. The package delivery rescheduling service 410 can continue to monitor the availability status of the intended recipient to determine further updates to the delivery schedule if the availability status of the intended recipient changes (e.g., the intended recipient is available earlier and/or not available during the updated package delivery schedule).

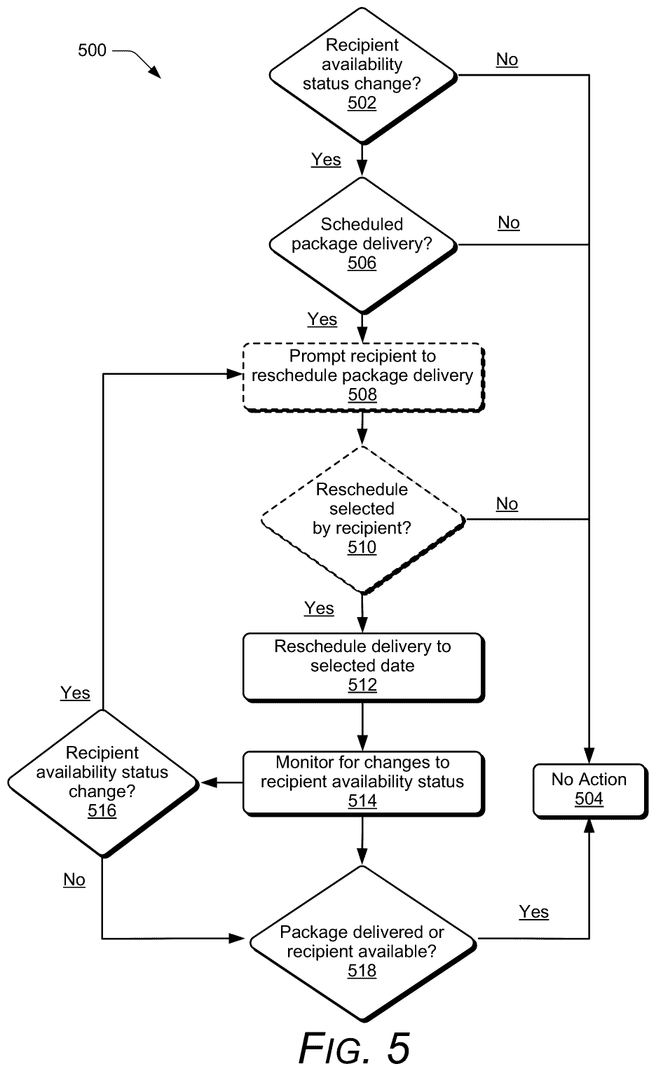

FIG. 5 illustrates an example process flow 500, which supports determining recipient availability for rescheduling package delivery in accordance with one or more implementations as described herein. The example process flow 500 may implement aspects of the example system 100, as well as any of the example user interface 200, the example user interface 300, or the block diagram 400. For example, the example process flow 500 can be implemented by a device 102, which may be an example of a device 102 as described with reference to FIGS. 1 through 4. Alternative examples of the following may be implemented, where some processes are performed in a different order than described or are not performed. In some cases, processes may include additional features not mentioned below, or further processes may be added.

At 502, a device determines whether an availability status of a recipient of a package delivery has changed (e.g., a device 102 as described with reference to FIG. 1). For example, the device obtains application data that indicates an availability status of a recipient to receive a package delivery during a scheduled delivery. In some examples, the application data includes at least one of calendar information of the recipient, travel information of the recipient, correspondence information of the recipient, home automation system information associated with the recipient, or location information of the recipient. The device determines at least one of a first duration for which the recipient is available to receive a package delivery or a second duration for which the recipient is unavailable to receive a package delivery from the application data. For example, the device determines an intended recipient of the package is at a delivery location for the first duration, but not at the delivery location for the second duration. At 504, if the availability status of the recipient has not changed (e.g., the recipient remains available or remains unavailable), then no action is taken.

At 506, if the availability status of the recipient changes (e.g., from available to unavailable), then the device determines whether there is a scheduled package delivery for the recipient. At 504, if there is not a scheduled package delivery, then no action is taken.

In some examples, at 508, if there is a scheduled package delivery while the delivery status of the recipient is unavailable, then the intended recipient of the package is prompted to reschedule the package delivery. For example, the device displays an indication that the package delivery is scheduled to occur when the availability status of the recipient is unavailable, as well as an indication of the updated schedule (e.g., recommended delivery schedule), as described with respect to FIGS. 2 and 3.

In some examples, at 510, the device determines whether rescheduling the package delivery is selected by the recipient. If the device receives instructions to reschedule the package delivery in response to the indication, then rescheduling the package delivery is selected by the recipient. The instructions can indicate the updated schedule (e.g., a new delivery date and/or time for which the recipient is available). If the device does not receive instructions to reschedule the package delivery in response to the indication, then no action is taken.

At 512, the delivery of the package is rescheduled to a selected date. In some examples, the device autonomously selects the date (e.g., independent of user input) by analyzing the application data to determine the recipient is available to receive the package delivery according to the selected date. The device can notify the recipient of the selected date. In some other examples, the recipient selects the date via a user interface, as described with reference to FIGS. 2 and 3.

At 514, changes to an availability status of a recipient are monitored. The device can periodically access a database to obtain additional application data that indicates whether the recipient is available or unavailable for the rescheduled delivery. The device can monitor the availability status of the recipient until delivery of the package (e.g., according to a rescheduled delivery or updated package delivery schedule).

At 516, the device determines whether there is a change in the availability status of the recipient during, or prior to, the rescheduled delivery (e.g., the recipient becomes unavailable during the rescheduled delivery and/or the recipient becomes available prior to the rescheduled delivery). If availability status of the recipient changes during, or prior to, the rescheduled delivery, then the device can prompt the recipient to reschedule the package delivery at 508 and can continue with the process described at 510, 512, and 514. If the recipient becomes available to receive the package prior to the rescheduled delivery, then the device can determine an additional updated schedule for delivery of the package that occurs prior to the rescheduled delivery.

At 518, if there are no changes to the availability status of the recipient, the device determines whether the package is delivered and/or whether the recipient is available to receive the package according to the scheduled delivery. If the package is delivered and/or if the recipient is available to receive the package according to the rescheduled delivery, then no action is taken.

In some examples, the device can determine the availability status of the recipient prior to an order for an item in the package is placed. The device can display a prompt indicating for the recipient to select a different delivery date for the package, where the different delivery date is a recommended delivery date during which the device predicts the recipient to be available. The intended recipient can provide input selecting an updated schedule for delivery (e.g., selecting the different delivery date).

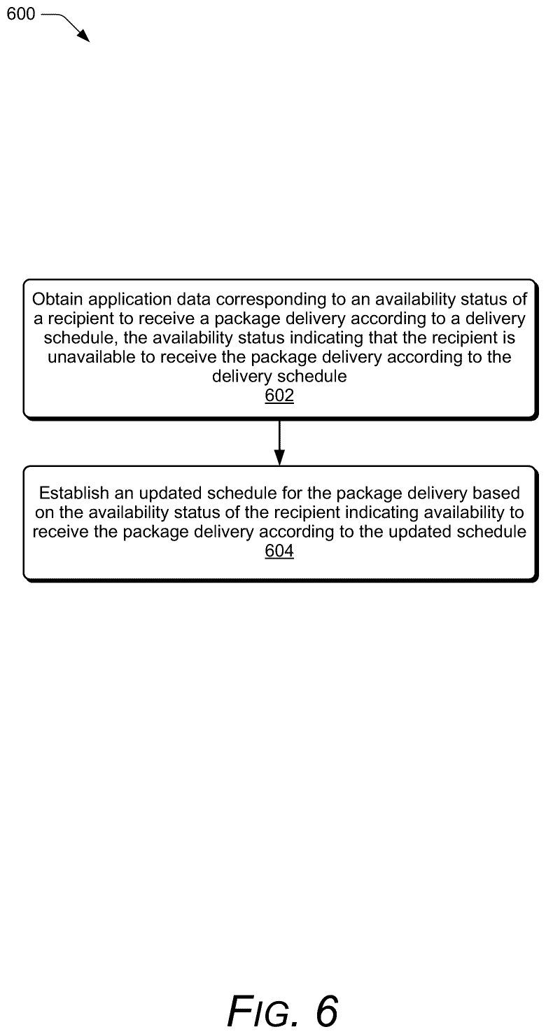

The example process flow 500, as well as example method 600, are described with reference to respective FIGS. 5 and 6 in accordance with one or more implementations of determining recipient availability for rescheduling package delivery, as described herein. Generally, any services, components, modules, managers, controllers, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 6 illustrates one or more example methods 600 for determining recipient availability for rescheduling package delivery. The order in which the method is described is not intended to be construed as a limitation, and any number or combination of the described method operations can be performed in any order to perform a method, or an alternate method.

At 602, application data corresponding to an availability status of a recipient to receive a package delivery according to a delivery schedule is obtained. The availability status indicates that the recipient is unavailable to receive the package delivery according to the delivery schedule. For example, the package delivery manager 110 can access a database at a device to obtain the application data. In some examples, the application data includes at least one of a first duration for which the recipient is available to receive the package delivery or a second duration for which the recipient is unavailable to receive the package delivery. Additionally, or alternatively, the application data includes at least one of calendar information of the recipient, travel information of the recipient, correspondence information of the recipient, home automation system information associated with the recipient, or location information of the recipient.

At 604, an updated schedule for the package delivery is established based on the availability status of the recipient indicating availability to receive the package delivery according to the updated schedule. For example, the package delivery manager 110 displays an indication that the package delivery is scheduled to occur when the availability status of the recipient is unavailable and an indication of the updated schedule. The package delivery manager 110 receives instructions to reschedule the package delivery according to the updated schedule in response to the indication. In some other examples, the package delivery manager 110 analyzes the application data to determine the recipient is available to receive the package delivery according to the updated schedule.

In some examples, additional application data corresponding to the availability status of the recipient is monitored according to the updated schedule. For example, the package delivery manager 110 can monitor the availability status of the recipient until delivery of the package when the additional application data indicates the recipient is available to receive the package delivery according to the updated schedule. The package delivery manager 110 can obtain the additional application data from a database (e.g., periodically). In some cases, the additional application data indicates the recipient is unavailable to receive the package delivery according to the updated schedule and the package delivery manager 110 determines an additional updated schedule for the package delivery based on the availability status of the recipient indicating availability to receive the package delivery according to the additional updated schedule. In some other cases, the additional application data indicates the recipient is available to receive the package delivery prior to the updated schedule and the package delivery manager 110 determines an additional updated schedule for the package delivery based on the availability status of the recipient indicating availability to receive the package delivery according to the additional updated schedule, where the additional updated schedule occurs prior to the updated schedule.

In some examples, the package delivery manager 110 determines the recipient is unavailable to receive the package delivery according to the delivery schedule prior to an order being placed for an item associated with the package delivery. A user interface of the device displays the updated schedule and an indication for the recipient to select a different delivery date. The package delivery manager 110 receives confirmation to reschedule the package delivery according to the updated schedule.

FIG. 7 illustrates various components of an example device 700, which can implement aspects of the techniques and features for determining recipient availability for rescheduling package delivery, as described herein. The example device 700 can be implemented as any of the devices described with reference to the previous FIGS. 1 through 6, such as any type of a wireless device, mobile device (e.g., the device 102), mobile phone, flip phone, client device, companion device, paired device, display device, tablet, computing, communication, entertainment, gaming, media playback, and/or any other type of computing, consumer, and/or electronic device. For example, the device 102 described with reference to FIGS. 1 through 6 may be implemented as the example device 700.

The example device 700 can include various, different communication devices 702 that enable wired and/or wireless communication of device data 704 with other devices. The device data 704 can include any of the various device's data and content that is generated, processed, determined, received, stored, and/or communicated from one computing device to another. Generally, the device data 704 can include any form of audio, video, image, graphics, and/or electronic data that is generated by applications executing on a device. The communication devices 702 can also include transceivers for cellular phone communication and/or for any type of network data communication.

The example device 700 can also include various, different types of data input/output (I/O) interfaces 706, such as data network interfaces that provide connection and/or communication links between the devices, data networks, and other devices. The I/O interfaces 706 can be used to couple the device to any type of components, peripherals, and/or accessory devices, such as a computer input device that may be integrated with the example device 700. The I/O interfaces 706 may also include data input ports via which any type of data, information, media content, communications, messages, and/or inputs can be received, such as user inputs to the device, as well as any type of audio, video, image, graphics, and/or electronic data received from any content and/or data source.

The example device 700 includes a processor system 708 of one or more processors (e.g., any of microprocessors, controllers, and the like) and/or a processor and memory system implemented as a system-on-chip (SoC) that processes computer-executable instructions. The processor system 708 may be implemented at least partially in computer hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively, or in addition, the device can be implemented with any one or combination of software, hardware, firmware, or fixed logic circuitry that may be implemented in connection with processing and control circuits, which are generally identified at 710. The example device 700 may also include any type of a system bus or other data and command transfer system that couples the various components within the device. A system bus can include any one or combination of different bus structures and architectures, as well as control and data lines.

The example device 700 also includes memory and/or memory devices 712 (e.g., computer-readable storage memory) that enable data storage, such as data storage devices implemented in hardware which can be accessed by a computing device, and that provide persistent storage of data and executable instructions (e.g., software applications, programs, functions, and the like). Examples of the memory devices 712 include volatile memory and non-volatile memory, fixed and removable media devices, and any suitable memory device or electronic data storage that maintains data for computing device access. The memory devices 712 can include various implementations of random-access memory (RAM), read-only memory (ROM), flash memory, and other types of storage media in various memory device configurations. The example device 700 may also include a mass storage media device.

The memory devices 712 (e.g., as computer-readable storage memory) provide data storage mechanisms, such as to store the device data 704, other types of information and/or electronic data, and various device applications 714 (e.g., software applications and/or modules). For example, an operating system 716 can be maintained as software instructions with a memory device 712 and executed by the processor system 708 as a software application. The device applications 714 may also include a device manager, such as any form of a control application, software application, signal-processing and control module, code that is specific to a particular device, a hardware abstraction layer for a particular device, and so on.

In this example, the device 700 includes a package delivery manager 718 that implements various aspects of the described features and techniques described herein. The package delivery manager 718 can be implemented with hardware components and/or in software as one of the device applications 714, such as when the example device 700 is implemented as the device 102 described with reference to FIGS. 1 through 6. An example of the package delivery manager 718 is the package delivery manager 110 implemented in the device 102, such as a software application and/or as hardware components in the wireless device. In implementations, the package delivery manager 718 may include independent processing, memory, and logic components as a computing and/or electronic device integrated with the example device 700.

The example device 700 can also include a microphone 720 and/or camera devices 722, as well as proximity and/or motion sensors 724, such as may be implemented as components of an inertial measurement unit (IMU). The proximity and/or motion sensors 724 can be implemented with various sensors, such as a gyroscope, an accelerometer, and/or other types of motion sensors to sense motion of the device. The motion sensors 724 can generate sensor data vectors having three-dimensional parameters (e.g., rotational vectors in x, y, and z-axis coordinates) indicating location, position, acceleration, rotational speed, and/or orientation of the device. The example device 700 can also include one or more power sources 726, such as when the device is implemented as a wireless device and/or a device 102. The power sources may include a charging and/or power system, and can be implemented as a flexible strip battery, a rechargeable battery, a charged super-capacitor, and/or any other type of active or passive power source.

The example device 700 can also include an audio and/or video processing system 728 that generates audio data for an audio system 730 and/or generates display data for a display system 732. The audio system and/or the display system may include any types of devices or modules that generate, process, display, and/or otherwise render audio, video, display, and/or image data. Display data and audio signals can be communicated to an audio component and/or to a display component via any type of audio and/or video connection or data link. In implementations, the audio system and/or the display system are integrated components of the example device 700. Alternatively, the audio system and/or the display system are external, peripheral components to the example device.

In some aspects, the techniques described herein relate to a device, including at least one processor coupled with a memory, and a package delivery manager configured to cause the device to obtain application data corresponding to an availability status of a recipient to receive a package delivery according to a delivery schedule, the availability status indicating that the recipient is unavailable to receive the package delivery according to the delivery schedule, and establish an updated schedule for the package delivery based on the availability status of the recipient indicating availability to receive the package delivery according to the updated schedule.

In some aspects, the techniques described herein relate to a device, where to establish the updated schedule for the package delivery, the package delivery manager is configured to display the updated schedule and an indication that the package delivery is scheduled to occur when the availability status of the recipient is unavailable and receive confirmation to reschedule the package delivery according to the updated schedule.

In some aspects, the techniques described herein relate to a device, where to establish the updated schedule for the package delivery, the package delivery manager is configured to analyze the application data to determine the recipient is available to receive the package delivery according to the updated schedule.

In some aspects, the techniques described herein relate to a device, where the package delivery manager is configured to determine that the recipient is available to receive the package delivery prior to the delivery schedule and establish the updated schedule for the package delivery based on the availability status of the recipient indicating availability to receive the package delivery prior to the delivery schedule.

In some aspects, the techniques described herein relate to a device, where the package delivery manager is configured to monitor additional application data until the package delivery occurs according to the updated schedule.

In some aspects, the techniques described herein relate to a device, where the package delivery manager is configured to determine the recipient is unavailable to receive the package delivery according to the delivery schedule prior to an order being placed for an item associated with the package delivery, display the updated schedule and an indication for the recipient to select a different delivery date, and receive confirmation to reschedule the package delivery according to the updated schedule.

In some aspects, the techniques described herein relate to a device, where the application data includes at least one of a first duration for which the recipient is available to receive the package delivery or a second duration for which the recipient is unavailable to receive the package delivery.

In some aspects, the techniques described herein relate to a device, where the application data includes at least one of calendar information of the recipient, travel information of the recipient, correspondence information of the recipient, home automation system information associated with the recipient, or location information of the recipient.

In some aspects, the techniques described herein relate to a method including obtaining application data corresponding to an availability status of a recipient to receive a package delivery according to a delivery schedule, the availability status indicating that the recipient is unavailable to receive the package delivery according to the delivery schedule, and establishing an updated schedule for the package delivery based on the availability status of the recipient indicating availability to receive the package delivery according to the updated schedule.

In some aspects, the techniques described herein relate to a method, where establishing the updated schedule for the package delivery includes displaying the updated schedule and an indication that the package delivery is scheduled to occur when the availability status of the recipient is unavailable and receiving confirmation to reschedule the package delivery according to the updated schedule.

In some aspects, the techniques described herein relate to a method, where establishing the updated schedule for the package delivery includes analyzing the application data to determine the recipient is available to receive the package delivery according to the updated schedule.

In some aspects, the techniques described herein relate to a method, further including determining that the recipient is available to receive the package delivery prior to the delivery schedule and establishing the updated schedule for the package delivery based on the availability status of the recipient indicating availability to receive the package delivery prior to the delivery schedule.

In some aspects, the techniques described herein relate to a method, further including monitoring additional application data until the package delivery occurs according to the updated schedule.

In some aspects, the techniques described herein relate to a method, further including determining the recipient is unavailable to receive the package delivery according to the delivery schedule prior to an order being placed for an item associated with the package delivery, displaying the updated schedule and an indication for the recipient to select a different delivery date, and receiving confirmation to reschedule the package delivery according to the updated schedule.

In some aspects, the techniques described herein relate to a method, where the application data includes at least one of calendar information of the recipient, travel information of the recipient, correspondence information of the recipient, home automation system information associated with the recipient, or location information of the recipient.

In some aspects, the techniques described herein relate to a mobile device, including at least one processor coupled with a memory, a display device to display an availability status to receive a package delivery according to a delivery schedule, the availability status indicating that a recipient is unavailable to receive the package delivery according to the delivery schedule, and a package delivery manager configured to establish an updated schedule for the package delivery based on the availability status of the recipient to receive the package delivery according to the updated schedule.

In some aspects, the techniques described herein relate to a mobile device, where the display device is configured to display the updated schedule for the package delivery based on the availability status of the recipient, and the package delivery manager is configured to receive confirmation to reschedule the package delivery according to the updated schedule.

In some aspects, the techniques described herein relate to a mobile device, where the package delivery manager is configured to analyze application data to determine the recipient is available to receive the package delivery according to the updated schedule.

In some aspects, the techniques described herein relate to a mobile device, where the application data includes at least one of calendar information, travel information, correspondence information, home automation system information, or location information.

In some aspects, the techniques described herein relate to a mobile device, where the package delivery manager is configured to determine that the recipient is available to receive the package delivery prior to the delivery schedule and establish the updated schedule for the package delivery based on the availability status of the recipient indicating availability to receive the package delivery prior to the delivery schedule.

1. A device, comprising:
at least one processor coupled with a memory; and
a package delivery manager configured to cause the device to:
obtain application data corresponding to an availability status of a recipient to receive a package delivery according to a delivery schedule, the availability status indicating that the recipient is unavailable to receive the package delivery according to the delivery schedule; and
establish an updated schedule for the package delivery based on the availability status of the recipient indicating availability to receive the package delivery according to the updated schedule.

2. The device of claim 1, wherein to establish the updated schedule for the package delivery, the package delivery manager is configured to:
display the updated schedule and an indication that the package delivery is scheduled to occur when the availability status of the recipient is unavailable; and
receive confirmation to reschedule the package delivery according to the updated schedule.

3. The device of claim 1, wherein to establish the updated schedule for the package delivery, the package delivery manager is configured to analyze the application data to determine the recipient is available to receive the package delivery according to the updated schedule.

4. The device of claim 1, wherein the package delivery manager is configured to:
determine that the recipient is available to receive the package delivery prior to the delivery schedule; and
establish the updated schedule for the package delivery based on the availability status of the recipient indicating availability to receive the package delivery prior to the delivery schedule.

5. The device of claim 1, wherein the package delivery manager is configured to monitor additional application data until the package delivery occurs according to the updated schedule.

6. The device of claim 1, wherein the package delivery manager is configured to:
determine the recipient is unavailable to receive the package delivery according to the delivery schedule prior to an order being placed for an item associated with the package delivery;
display the updated schedule and an indication for the recipient to select a different delivery date; and
receive confirmation to reschedule the package delivery according to the updated schedule.

7. The device of claim 1, wherein the application data includes at least one of a first duration for which the recipient is available to receive the package delivery or a second duration for which the recipient is unavailable to receive the package delivery.

8. The device of claim 1, wherein the application data includes at least one of calendar information of the recipient, travel information of the recipient, correspondence information of the recipient, home automation system information associated with the recipient, or location information of the recipient.

9. A method comprising:
obtaining application data corresponding to an availability status of a recipient to receive a package delivery according to a delivery schedule, the availability status indicating that the recipient is unavailable to receive the package delivery according to the delivery schedule; and
establishing an updated schedule for the package delivery based on the availability status of the recipient indicating availability to receive the package delivery according to the updated schedule.

10. The method of claim 9, wherein establishing the updated schedule for the package delivery comprises:
displaying the updated schedule and an indication that the package delivery is scheduled to occur when the availability status of the recipient is unavailable; and
receiving confirmation to reschedule the package delivery according to the updated schedule.

11. The method of claim 9, wherein establishing the updated schedule for the package delivery comprises analyzing the application data to determine the recipient is available to receive the package delivery according to the updated schedule.

12. The method of claim 9, further comprising:
determining that the recipient is available to receive the package delivery prior to the delivery schedule; and
establishing the updated schedule for the package delivery based on the availability status of the recipient indicating availability to receive the package delivery prior to the delivery schedule.

13. The method of claim 9, further comprising monitoring additional application data until the package delivery occurs according to the updated schedule.

14. The method of claim 9, further comprising:
determining the recipient is unavailable to receive the package delivery according to the delivery schedule prior to an order being placed for an item associated with the package delivery;
displaying the updated schedule and an indication for the recipient to select a different delivery date; and
receiving confirmation to reschedule the package delivery according to the updated schedule.

15. The method of claim 9, wherein the application data includes at least one of calendar information of the recipient, travel information of the recipient, correspondence information of the recipient, home automation system information associated with the recipient, or location information of the recipient.

16. A mobile device, comprising:
at least one processor coupled with a memory;
a display device to display an availability status to receive a package delivery according to a delivery schedule, the availability status indicating that a recipient is unavailable to receive the package delivery according to the delivery schedule; and
a package delivery manager configured to establish an updated schedule for the package delivery based on the availability status of the recipient to receive the package delivery according to the updated schedule.

17. The mobile device of claim 16, wherein:
the display device is configured to display the updated schedule for the package delivery based on the availability status of the recipient; and
the package delivery manager is configured to receive confirmation to reschedule
the package delivery according to the updated schedule.

18. The mobile device of claim 16, wherein the package delivery manager is configured to analyze application data to determine the recipient is available to receive the package delivery according to the updated schedule.

19. The mobile device of claim 18, wherein the application data includes at least one of calendar information, travel information, correspondence information, home automation system information, or location information.

20. The mobile device of claim 16, wherein the package delivery manager is configured to:
determine that the recipient is available to receive the package delivery prior to the delivery schedule; and
establish the updated schedule for the package delivery based on the availability status of the recipient indicating availability to receive the package delivery prior to the delivery schedule.
